(19) United States
(12) Patent Application Publication
(10) Pub. No.: US 2024/0160950 A1
(43) Pub. Date: May 16, 2024

(54) METHOD AND DEVICE FOR PROCESSING NEURAL NETWORK MODEL FOR CIRCUIT SIMULATOR

(71) Applicant: ALSEMY INC., Seoul (KR)

(72) Inventors: Myoung Nyoun KIM, Seoul (KR); Jin Wook SHIN, Seoul (KR); Ji Yong KIM, Seoul (KR)

(21) Appl. No.: 18/468,228

(22) Filed: Sep. 15, 2023

(30) Foreign Application Priority Data
Nov. 10, 2022 (KR) 10-2022-0149702

(51) Int. Cl. G06N 3/10

(52) U.S. Cl. CPC G06N 3/10

(57) ABSTRACT

A method of processing a neural network model for a circuit simulator can include reading a source file input to a circuit simulator, reading a neural network file when the source file is read, and generating a lookup table using size information of a semiconductor device included in the source file and parameters included in the neural network file.

### BACKGROUND

### 1. Field of the Invention

The present invention relates to a method and device for processing a neural network model for a circuit simulator, and more particularly, to a method and device for processing a neural network model for a circuit simulator for reducing a simulation time of a circuit simulator.

### 2. Discussion of Related Art

A circuit simulator uses a mathematical model to simulate an operation of real electronic circuits. A simulation program with integrated circuit emphasis (SPICE) is an open source analog electronic circuit simulator.

A compact model models an electrical operation of a semiconductor device. The compact model is used in the circuit simulator.

Recently, attempts have been made to implement the compact model using a neural network model. Korean Patent Publication No. 10-2285516 relates to a technique for implementing a compact model using a neural network model.

In Korean Patent Publication No. 10-2285516, results output from a machine learning manager is converted into a lookup table (LUT). In Korean Patent Publication No. 10-2285516, the converted LUT is generated as a file, and the generated file is stored in a non-volatile memory device such as a solid state drive (SSD). When the LUT is stored in the non-volatile memory device, a read time of the LUT is long. This is because the LUT is stored in the non-volatile memory device.

In addition, in Korean Patent Publication No. 10-2285516, all the LUTs should be generated in advance for each size of a semiconductor device. For example, assuming that there are transistor A with a width of 1 μm and a length of 1 μm, and transistor B with a width of 1 μm and a length of 1 μm, an LUT for the transistors A and B should be generated in advance. In addition, when even the same transistor has different widths and lengths, different LUTs should be generated in advance. For example, assuming that there are transistor A with a width of 1 μm and a length of 1 μm and transistor B with a width of 1 μm and a length of 2 μm, two LUTs should be generated in advance. In the related art, LUTs for various semiconductor devices should be generated in advance. This may lead to inefficiency in that an LUT that is not be utilized in the circuit simulator is also generated in advance.

### RELATED ART DOCUMENT

### Patent Document

(Patent Document 1) Korea Patent Publication No. 10-2285516 (Jul. 29, 2021)

### SUMMARY OF THE INVENTION

A technical problem to be achieved by the present invention provides a method and device for processing a neural network model for a circuit simulator for reducing a simulation time of a circuit simulator.

According to an exemplary embodiment, a method of processing a neural network model for a circuit simulator includes reading a source file input to a circuit simulator, reading a neural network file when the source file is read, and generating a lookup table (LUT) using size information of a semiconductor device included in the source file and parameters included in the neural network file.

The LUT may be stored in a volatile memory.

The LUT may not be generated when the source file is not read.

The generating of the LUT may include receiving a request signal for generating the LUT from the circuit simulator, confirming the parameters of the neural network file according to the request signal, allocating a storage space for the parameters to a volatile memory, confirming the size information of the semiconductor device, allocating a storage space for the size information of the semiconductor device to the volatile memory, and allocating a storage space for the LUT to the volatile memory.

The method may further include analyzing whether there is a section in which a current decreases when a bias voltage increases in the generated LUT, finding whether there is a voltage having a value greater than a value of the current in a voltage after an area in which the current decreases, when there is a section in which the current decreases as the bias voltage increases, and finding a first current value at a voltage at which the current starts to decrease and a second current value greater than the first current value at the voltage after the area in which the current decreases, when there is the voltage having the value greater than the value of the current, and connecting the first current value to the second current value.

According to another exemplary embodiment, a device for processing a neural network model for a circuit simulator includes a processor configured to execute instructions, and a volatile memory configured to store the instructions.

The instructions may be implemented to read a source file input to a circuit simulator, read a neural network file when the source file is read, and generate an LUT using size information of a semiconductor device included in the source file and parameters included in the neural network file.

### BRIEF DESCRIPTION OF THE DRAWINGS

In order to more fully understand the drawings cited in the detailed description of the present invention, a detailed description of each drawing is provided.

FIG. 1 is a diagram illustrating a block diagram of a device for processing a neural network model for a circuit simulator according to an embodiment of the present invention.

FIG. 2 is a block diagram for describing a method of processing a neural network model for a circuit simulator according to an embodiment of the present invention.

FIG. 3 is a flowchart for describing the method of processing a neural network model for a circuit simulator according to an embodiment of the present invention.

FIG. 4 is a flowchart for describing an operation of generating a lookup table (LUT) illustrated in FIG. 3 in detail.

FIGS. 5A and 5B are graphs for describing a negative differential resistance (NDR) compensation module illustrated in FIG. 2.

### DETAILED DESCRIPTION OF EXEMPLARY EMBODIMENTS

Specific structural or functional descriptions disclosed in the present specification will be provided only in order to describe exemplary embodiments of the present invention. Therefore, exemplary embodiments of the present invention may be implemented in various forms, and the present invention is not to be interpreted as being limited to exemplary embodiments described in the present specification.

Since embodiments according to concepts of the present invention may be variously modified and may have several forms, they will be shown in the accompanying drawings and be described in detail in the present specification. However, it is to be understood that exemplary embodiments of the present invention are not limited to specific forms, but includes all modifications, equivalents, and substitutions included in the spirit and the scope of the present invention.

Terms such as “first,” “second,” or the like, may be used to describe various components, but these components are not to be construed as being limited to these terms. The terms are used only to distinguish one component from another component. For example, the “first” component may be named the “second” component and the “second” component may also be similarly named the “first” component, without departing from the scope of the present invention.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, all the terms used in the present specification, including technical and scientific terms, have the same meanings as meanings that are generally understood by those skilled in the art to which the present invention pertains. Terms generally used and defined in a dictionary are to be interpreted as the same meanings with meanings within the context of the related art, and are not to be interpreted as ideal or excessively formal meanings unless clearly indicated in the present specification.

Hereinafter, exemplary embodiments of the present invention will be described in detail with reference to the accompanying drawings.

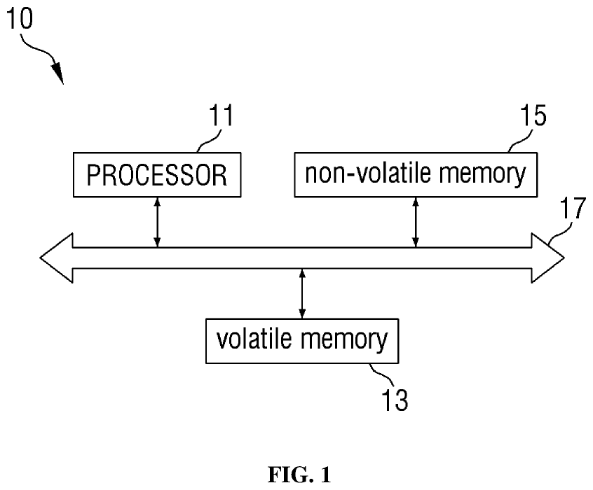

FIG. 1 is a diagram illustrating a block diagram of a device for processing a neural network model for a circuit simulator according to an embodiment of the present invention.

Referring to FIG. 1, a device 10 for processing a neural network model for a circuit simulator is a computing device. The computing device is an electronic device such as a computer, a laptop, a server, a smart phone, or a tablet PC. According to an embodiment, the device 10 for processing a neural network model for a circuit simulator may be called various terms such as an electronic device.

The device 10 for processing a neural network model for a circuit simulator includes a processor 11, a non-volatile memory 15, a volatile memory 13, and a bus 17.

The processor 11 executes neural network model processing instructions for the circuit simulator.

The volatile memory 13 stores the instructions. The volatile memory 13 may be dynamic random access memory (DRAM).

According to the embodiment, the instructions may be stored in the non-volatile memory 15. The non-volatile memory 15 may be a solid state drive (SSD).

The processor 11, the volatile memory 13, and the non-volatile memory 15 may exchange data through a bus 17. The bus 17 may be implemented in various ways for communication between the processor 11, the volatile memory 13, and the non-volatile memory 15.

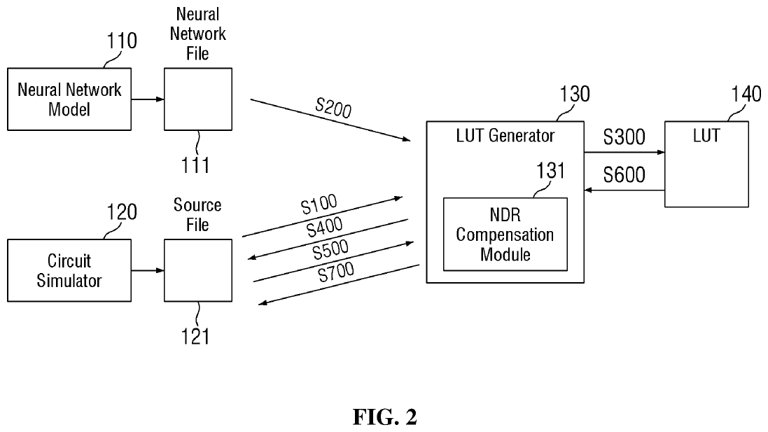

FIG. 2 is a block diagram for describing a method of processing a neural network model for a circuit simulator according to an embodiment of the present invention.

Referring to FIGS. 1 and 2, a neural network model 110, a circuit simulator 120, and a lookup table (LUT) generator 130 may be implemented as respective programs. The neural network model 110, the circuit simulator 120, and the LUT generator 130 refer to programs or software executed by the processor 11. Hereinafter, it should be understood that operations of the neural network model 110, the circuit simulator 120, and the LUT generator 130 are performed by the processor 11.

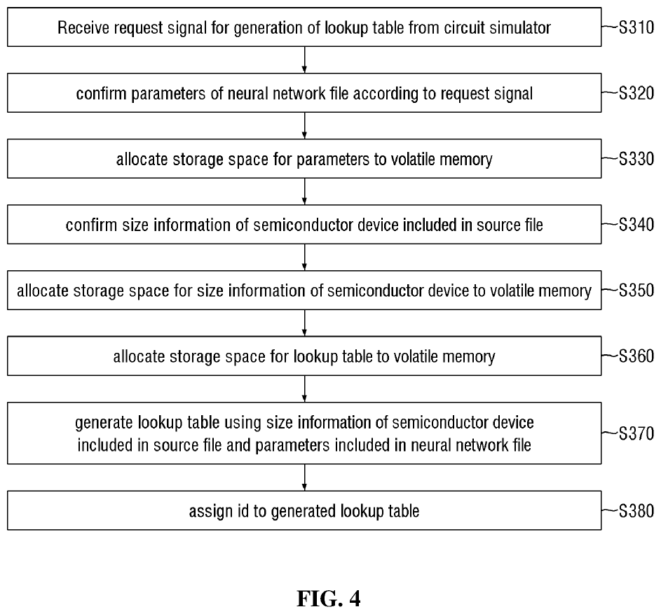

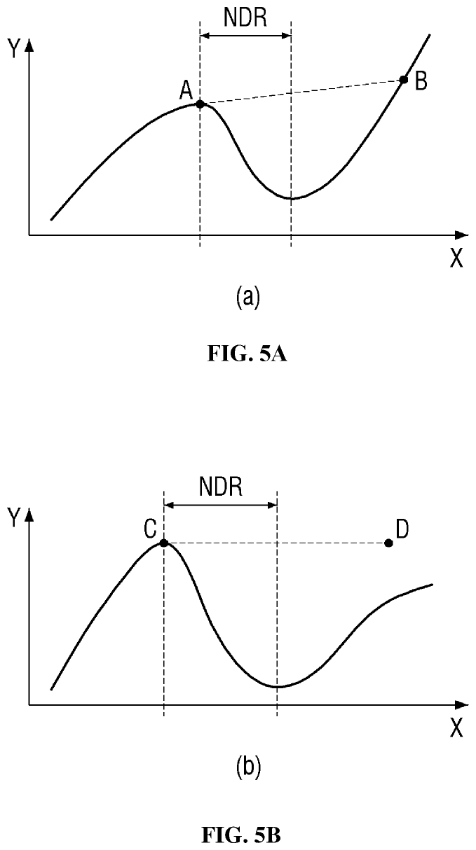

The neural network model 110 includes a neural network for implementing a compact model. The neural network is a trained neural network. For example, the neural network may be the model of FIG. 4 or the model of FIG. 5 shown in Korean Patent Publication No. 10-2285516. The neural network model 110 generates a neural network file 111. The neural network file 111 includes parameters for the neural network. The parameters include weights. The neural network file 111 is a binary file. The neural network file 111 is stored in the volatile memory 13 or the non-volatile memory 15.

The neural network model 110 may correspond to a machine learning manager 140 shown in Korean Patent Publication No. 10-2285516.

The circuit simulator 120 is a computer simulation and modeling program for mathematically predicting a behavior of electronic circuits. In the circuit simulator 120, the input file 121 may be called the source file.

In the circuit simulator 120, the input file 121 includes interconnections with components of the circuit, a type of analysis in the circuit, and a type of output of the circuit simulator 120. Components of the circuit include resistors, inductors, capacitors, DC power supplies, AC power supplies, and semiconductor devices. The semiconductor device includes diodes or transistors. In this case, the size information of the semiconductor device, for example, width, length, or temperature information may be included. The types of analysis in the circuit may include frequency analysis, transient analysis over a specific time interval, and DC operating point analysis. The DC operating point analysis means analyzing a voltage at a node, and a current at each voltage source, a current or voltage at each component when it is a DC voltage. The type of output may include a print type expressed as text or a plot type expressed as a graph. The interconnection with the components of the circuit may be a netlist.

The input file 121 in the circuit simulator 120 is generated by a user using the circuit simulator 120. That is, the input file 121 is generated when the user inputs information about the interconnection with the components of the circuit, the type of analysis in the circuit, and the type of output. The input file 121 may be stored in the volatile memory 13 or the non-volatile memory 15.

The output file of the circuit simulator 120 includes information about the current in the circuit, or a voltage at a particular node. The output file of circuit simulator 120 is a text file. The information about the current in the circuit or the voltage at the particular node included in the output file of the circuit simulator 120 may be called an operating point.

In order to obtain the output file in the circuit simulator 120, a compact model of a semiconductor device, which is the component of the circuit, is required.

The compact model may be implemented in the form of the LUT. For example, a channel width, a length, a gate-source voltage, a drain-source voltage, and a drain current with respect to a source-bulk voltage of a transistor may be implemented in the form of the LUT.

In Korean Patent Publication No. 10-2285516, the LUT generator converts the results output from a machine learning manager into the LUT. In this case, in Korean Patent Publication No. 10-2285516, the LUT generator converts the results output from a machine learning manager into the LUT regardless of the circuit simulator 120.

In Korean Patent Registration No. 10-2285516, the LUT generator should generate the LUT in advance for each size of the semiconductor device. For example, assuming that there are transistor A with a width of 1 μm and a length of 1 and transistor B with a width of 1 μm and a length of 1 an LUT for the transistors A and B should be generated in advance. In addition, when even the same transistor has different widths and lengths, different LUTs should be generated in advance. For example, assuming that there are transistor A with a width of 1 μm and a length of 1 μm and transistor B with a width of 1 μm and a length of 2 two LUTs should be generated in advance. In the related art, all the LUTs should be generated in advance for various semiconductor devices. This is because the circuit simulators in the related art directly read pre-generated LUTs from an LUT generator in order to know an electrical operation of a specific semiconductor device. This may lead to inefficiency in that the LUT that is not be utilized in the circuit simulator is also generated in advance. In addition, the LUT is generated as a text file and stored in the non-volatile memory device such as the SSD. When the LUT is stored in the non-volatile memory, the time it takes for the processor to read the lookup table is longer than the time it takes for the lookup table to be stored in volatile memory.

In the present invention, unlike the related art, the LUT is not generated by the LUT generator, but is different in that the LUT is generated in real time when the source file 121 of the circuit simulator 120 is read. The reading of the source file 121 means that the input file 121 stored in the volatile memory 13 or the non-volatile memory 15 is loaded into the processor 11.

In FIG. 2, the LUT generator 130 corresponds to the LUT generator 191 in Korean Patent Publication No. 10-2285516, but the present invention differs from Korean Patent Publication No. 10-2285516 in that the LUT generator 130 is related to the operation of the circuit simulator 120 to generate the LUT 140. That is, in the present invention, the LUT 140 is dependent on the operation of the circuit simulator 120, but in Korean Patent Publication No. 10-2285516 which is the related art, the LUT is independent of the operation of the circuit simulator. In Korean Patent Publication No. 10-2285516 which is the related art, the LUT is generated regardless of the operation of the circuit simulator.

Hereinafter, the operation of generating the LUT 140 in the present invention will be described in detail.

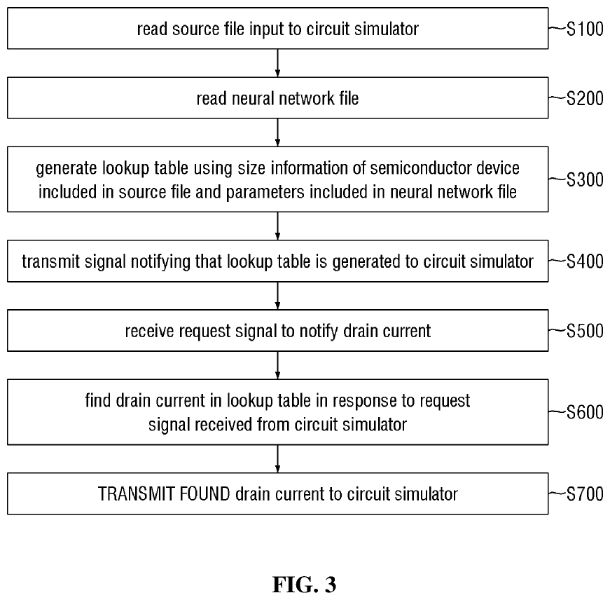

FIG. 3 is a flowchart for describing the method of processing a neural network model for a circuit simulator according to an embodiment of the present invention.

Referring to FIGS. 1 to 3, the LUT generator 130 reads the source file 121 input to the circuit simulator 120 (S100). The source file 121 may include the size information (e.g., channel width or length of a transistor) of the semiconductor devices. When the source file 121 is generated by the circuit simulator 120, the circuit simulator 120 transmits the source file 121 to the LUT generator 130.

When the source file 121 is read, the LUT generator 130 reads the neural network file 111 (S200). That is, reading the neural network file 111 means that the processor 11 loads weights included in the neural network stored in the volatile memory 13 or the non-volatile memory 15.

The LUT generator 130 generates the LUT 140 using the size information of the semiconductor device included in the source file 121 and the parameters included in the neural network file 111 (S300). For example, when the size information of the semiconductor device included in the source file 121 includes information on a transistor with a width of 1 μm and a length of 1 μm, the LUT generator 130 may use the parameters included in the neural network file 111 to generate the LUT 140 for the transistor having a width of 1 μm and a length of 1 μm When the transistor has the width of 1 μm and the length of 1 μm, the LUT 140 contains information about a drain current with respect to a gate-source voltage.

FIG. 4 is a flowchart for describing an operation of generating the LUT illustrated in FIG. 3 in detail.

Referring to FIGS. 1 to 4, the LUT generator 130 receives a request signal for generating the LUT 140 from the circuit simulator 120 (S310).

The LUT generator 130 confirms the parameters of the neural network file 111 according to the request signal (S320).

The LUT generator 130 allocates a storage space for the parameters to the volatile memory 13 (S330).

The LUT generator 130 confirms the size information of the semiconductor device included in the source file 121 (S340).

The LUT generator 130 allocates a storage space for the size information of the semiconductor device to the volatile memory 13 (S350).

The LUT generator 130 allocates a storage space for the LUT 140 to the volatile memory 13 (S360).

The LUT generator 130 generates the LUT 140 using the size information of the semiconductor device included in the source file 121 and the parameters included in the neural network file 111 (S370).

The LUT generator 130 assigns an ID to the generated LUT 140 (S380).

Referring to FIGS. 1 to 3, the generated LUT 140 is stored in a volatile memory 13 such as dynamic random access memory (DRAM). In the case of the related art, the generated LUT is stored in the non-volatile memory.

When several semiconductor devices are included in the source file 121 or one type of semiconductor devices having different sizes are included in the source file 121, the LUT generator 130 may generate several LUTs 140. For example, when two different types of transistors (p-channel metal-oxide semiconductor (PMOS) and n-channel metal-oxide semiconductor (NMOS)) are included in the source file 121, the LUT generator 130 generates two LUTs 140. In addition, even if one type of transistor is included in the source file 121, when two PMOS transistors having different sizes are included in the source file 121, the LUT generator 130 generates two LUTs 140.

The LUT generator 130 transmits a signal notifying that the LUT 140 is generated to the circuit simulator 120 (S400). In this case, the LUT generator 130 may transmit the ID of the generated LUT 140 together.

The LUT generator 130 receives a request signal from the circuit simulator 120 to notify a drain current ID under specific conditions (e.g., when the width is 1 μm the length is 1 μm the gate-source voltage VGS is 1.5V, and the drain-source voltage VDS is 1.7 V) (S500).

The LUT generator 130 finds the drain current ID in the LUT 140 in response to the request signal received from the circuit simulator 120 (S600).

The LUT generator 130 transmits the found drain current ID to the circuit simulator 120 (S700). The LUT generator 130 deletes the LUT 140 stored in the volatile memory 13 such as DRAM.

The circuit simulator 120 generates an output file for the source file 121 using the drain current (ID).

FIGS. 5A and 5B are graphs for describing a negative differential resistance (NDR) compensation module illustrated in FIG. 2.

In FIGS. 5A and 5B, an X axis represents, a voltage, for example, the bias voltage of the transistor, and a Y axis represents a current, for example, a drain-source current of the transistor. A negative differential resistance (NDR) means an electrical characteristic in which a current decreases when a voltage increases.

Referring to FIGS. 2, 5A, and 5B, the NDR may be analyzed by the LUT 140. In the LUT 140, there may be a section in which the current decreases even though the voltage increases. The section is called the NDR section. When the NDR section is used in the circuit simulator 120, the output of the circuit simulator 120 may be abnormal. The output may have a divergence value. Therefore, the NDR section in the LUT 140 needs to be corrected.

The LUT generator 130 may include an NDR compensation module 131.

The NDR compensation module 131 may be implemented as part of LUT generator 130. That is, the NDR compensation module 131 may also be implemented as a program.

The NDR compensation module 131 analyzes whether there is a section (NDR section) in which the current decreases when the bias voltage in the LUT 140 increases.

When there is an area (NDR section) in which the current decreases as the bias voltage increases, the NDR compensation module 131 finds whether there is a voltage (point B in FIG. 5A) greater than the current value in a voltage after an area (NDR section) in which the current decreases.

When there is a point (point B in FIG. 5A) having a value greater than the current value, the NDR compensation module 131 finds a first current value (point A in FIG. 5A) at a voltage at which the current starts to decrease and a second current value at a voltage (point B in FIG. 5A) having a value greater than the first current value in the voltage after an area (NDR section) in which the current decreases and connects the points to each other. In FIG. 5A, the NDR compensation module 131 may remove the NDR section by connecting points A and B to each other.

When there is no point (point B in FIG. 5A) having a value greater than the current value (in the case of FIG. 5B), the NDR compensation module 131 sets current values after the voltage (point C in FIG. 5B) at which the current starts to decrease as a third current value at the voltage (point C in FIG. 5B) at which the current starts to decrease. The NDR compensation module 131 may remove the NDR section by making point D in FIG. 5B have the same current value as the point C. The point D means up to a voltage range present in the LUT 140.

A method and device for processing a neural network model for a circuit simulator according to an embodiment of the present invention does not generate an LUT in advance, but generates an LUT only when a source file input to the circuit simulator is read, and thus there is no need to generate an unnecessary LUT in advance.

In addition, a method and device for processing a neural network model for a circuit simulator according to an embodiment of the present invention does not generate an LUT in advance, but generates an LUT in real time, and thus the generated LUT can be stored in a non-volatile memory device instead of a non-volatile memory device. This has the effect of reducing a read time of the LUT.

Although the present invention has been described with reference to exemplary embodiments shown in the accompanying drawings, it is only an example. It will be understood by those skilled in the art that various modifications and equivalent other exemplary embodiments are possible from the present invention. Accordingly, an actual technical protection scope of the present invention is to be defined by the following claims.

What is claimed is:

1. A method of processing a neural network model for a circuit simulator, comprising:
reading a source file input to a circuit simulator;
reading a neural network file when the source file is read; and
generating a lookup table (LUT) using size information of a semiconductor device included in the source file and parameters included in the neural network file.

2. The method of claim 1, wherein the LUT is stored in a volatile memory.

3. The method of claim 1, wherein the LUT is not generated when the source file is not read.

4. The method of claim 1, wherein the generating of the LUT includes:
receiving a request signal for generating the LUT from the circuit simulator;
confirming the parameters of the neural network file according to the request signal;
allocating a storage space for the parameters to a volatile memory;
confirming the size information of the semiconductor device;
allocating a storage space for the size information of the semiconductor device to the volatile memory; and
allocating a storage space for the LUT to the volatile memory.

5. The method of claim 1, further comprising:
analyzing whether there is a section in which a current decreases when a bias voltage increases in the generated LUT;
finding whether there is a voltage having a value greater than a value of the current in a voltage after an area in which the current decreases, when there is a section in which the current decreases as the bias voltage increases; and
finding a first current value at a voltage at which the current starts to decrease and a second current value greater than the first current value at the voltage after the area in which the current decreases, when there is the voltage having the value greater than the value of the current, and connecting the first current value to the second current value.

6. A device for processing a neural network model for a circuit simulator, comprising:
a processor configured to execute instructions; and
a volatile memory configured to store the instructions,
wherein the instructions are implemented to:
read a source file input to a circuit simulator;
read a neural network file when the source file is read; and
generate an LUT using size information of a semiconductor device included in the source file and parameters included in the neural network file.

7. The device of claim 6, wherein the LUT is stored in the volatile memory.

8. The device of claim 6, wherein the LUT is not generated when the source file is not read.

9. The device of claim 6, wherein the instructions to generate the LUT are implemented to:
receive a request signal for generating the LUT from the circuit simulator;
confirm the parameters of the neural network file according to the request signal;
allocate a storage space for the parameters to the volatile memory;
confirm size information of the semiconductor device;
allocate a storage space for the size information of the semiconductor device to the volatile memory; and
allocate a storage space for the LUT to the volatile memory.

10. The device of claim 6, wherein the instructions are implemented to:
analyze whether there is a section in which a current decreases when a bias voltage increases in the generated LUT;
find whether there is a voltage having a value greater than a value of the current in a voltage after an area in which the current decreases, when there is a section in which the current decreases as the bias voltage increases; and
find a first current value at a voltage at which the current starts to decrease and a second current value greater than the first current value at the voltage after the area in which the current decreases, when there is the voltage having the value greater than the value of the current, and connect the first current value to the second current value.
